(19) United States
(12) Patent Application Publication
(10) Pub. No.: US 2008/0165056 A1
(43) Pub. Date: Jul. 10, 2008

(54) Modular tracking device

(76) Inventor: Jeffrey Walter Bader, Monte Sereno, CA (US)

Correspondence Address: THELEN REID BROWN RAYSMAN & STEINER LLP, P. O. BOX 640640, SAN JOSE, CA, 95164-0640, US

(21) Appl. No.: 11/651,257

(22) Filed: Jan. 8, 2007

(51) Int. Cl. G01S 5/00

(52) U.S. Cl. 342/357.07; 340/686.1

(57) ABSTRACT

A tracking device and system is configured to be modular in nature and to include an interchangeable ICC (integrated circuit card) and an interchangeable power supply. The tracking device is customized for the particular application, and may be disposable. It contains componentry for determining its own location and for transmitting indications of this location in a pre-scheduled, event-driven or user query-responsive fashion to a central storage location accessible only to a properly-authenticated user. The tracking device may take any of a number of forms, including an adhesive strip containing affixable to the tracked object.

### CROSS-REFERENCE TO RELATE APPLICATIONS

(Not applicable)

### BACKGROUND OF THE INVENTION

1. Field of the Invention

The invention relates to tracking devices.

2. Description of the Related Art

Tracking devices are important expedients for providing information relating to the whereabouts of mobile objects. For instance, a package being shipped from one location to another can be tracked to determine its progress in transit, and to permit early intervention should deviations from a prescribed route be detected. Similarly, vehicles, for instance transport trucks carrying hazardous cargo, can be tracked in order to safeguard public safety and security and minimize opportunities for foul play. Livestock can also be tracked for public safety and economic advantage.

### BRIEF SUMMARY OF THE INVENTION

In accordance with one embodiment, there is described herein a tracking device includes a location module configured to determine location information relating to the tracking device, a communication module configured to transmit the location information, a processor in electrical communication with the location module and the communication module, an ICC (integrated circuit card) socket communicatively coupled to the processor, the socket configured to receive an interchangeable ICC such that the ICC, when received by the ICC socket, is in communication with the processor, and a power socket configured to receive an interchangeable power source and to distribute power from the interchangeable power source, when in the power socket, to the tracking device.

Also described is a system for tracking objects, the system including one or more tracking devices each associated with an object, the tracking devices each including a location module, a communication module configured to transmit location information, a processor, an ICC (integrated circuit card) socket communicatively coupled to the processor, the socket configured to receive an interchangeable ICC such that the ICC, when received by the ICC socket, is in communication with the processor, and a power socket configured to receive an interchangeable power source and to distribute power from the interchangeable power source, when in the power socket, to the tracking device. The tracking system also includes a server in communication with at least one of the tracking devices, the server configured to store location information transmitted by the communication module.

Also described is a method for tracking an object, the method including configuring a tracking device to track the object, the configuring including determining a tracking duration, securing communication access for the tracking device for the tracking duration, and securing power resources for the tracking device for said tracking duration. The method further includes coupling the tracking device to the object, and issuing information relating to the location of the object.

### BRIEF DESCRIPTION OF THE SEVERAL VIEWS OF THE DRAWINGS

Many advantages of the present invention will be apparent to those skilled in the art with a reading of this specification in conjunction with the attached drawings, wherein like reference numerals are applied to like elements, and wherein:

FIG. 1 is a schematic illustration of an example embodiment of a tracking system using modular tracking device.

FIG. 2 is a block diagram of an example of a tracking device;

FIG. 3 is a schematic diagram of an example of a tracking device;

FIG. 4 is an embodiment of a tracking device disposed on an adhesive strip adhered to a package; and

FIG. 5 is a flow diagram showing a tracking method of an object.

### DETAILED DESCRIPTION OF THE INVENTION

The description herein is provided in the context of a modular tracking device. Those of ordinary skill in the art will realize that the following detailed description is illustrative only and is not intended to be in any way limiting. Other embodiments will readily suggest themselves to such skilled persons having the benefit of this disclosure. Reference will now be made in detail to implementations as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

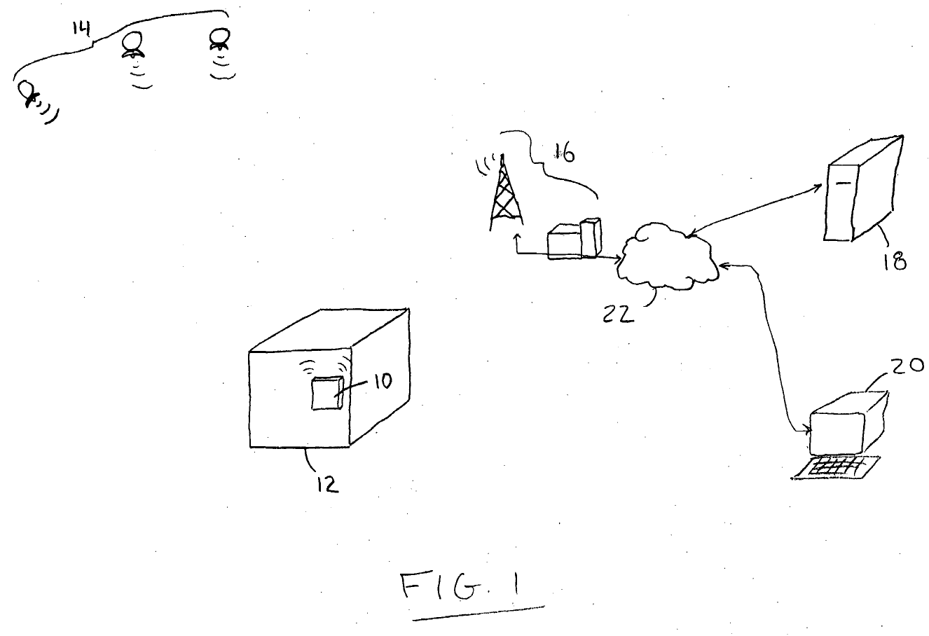

FIG. 1 is a schematic illustration of an example embodiment of a tracking system using a modular tracking device. The tracking device 10 is coupled to an object 12 being tracked. The object in this example is a package tracked for shipping purposes, but tracking other objects, as well as humans (children or elderly for instance) and animals (for example pets or livestock), is also contemplated, as is the tracking of vehicles such as aircraft, trucks, automobiles, seagoing vessels, military vehicles, and so forth.

Tracking device 10 is equipped with a location determining mechanism (not shown) that enables the determination of the location of the tracking device (and object) anywhere in three dimensions—that is, latitude, longitude, and altitude. Such a mechanism can for instance be a GPS (global positioning system), which communicates with an earth-orbiting satellite system 14 to make location determinations of the tracking device 10.

Using existing mobile communication infrastructure shown at 16, tracking device 10 is configured to communicate with a server 18 and/or with a computer 20, by way a network 22. Tracking device 10 issues a variety of operational information that is conveyed to either one or both the server 18 and the computer 20. Examples of such operational information include location information as described above, and status information such as remaining power capacity of the tracking device 10. In one embodiment, the operational information is provided to server 18. The information, or portions thereof, can then be retrieved by a user at computer 20 following proper authentication, which can include providing identification information pertaining to the particular tracking device and/or the object (package) with which it is associated, and optionally, identification information of the user or a user account.

The server 18 can operate as a repository of operational information for multiple tracking devices 10 associated with one or more users, each of whom has access to a prescribed set of one or more tracking devices only. The operational information or portions thereof can be manipulated at the server 18 and/or at the computer 20 for display according to user preference and convenience. For instance, a real-time map can be rendered at the user's computer 20, with a plot of the intended route of the tracking device 10 and its actual location in that route shown in the map. Computer 20 is not limited to a desktop personal computer. Rather, it may be a laptop computer, a personal digital assistant (PDA), or any other device capable of communicating with server 18 or even directly with tracking device 20, such as a mobile telephone for instance.

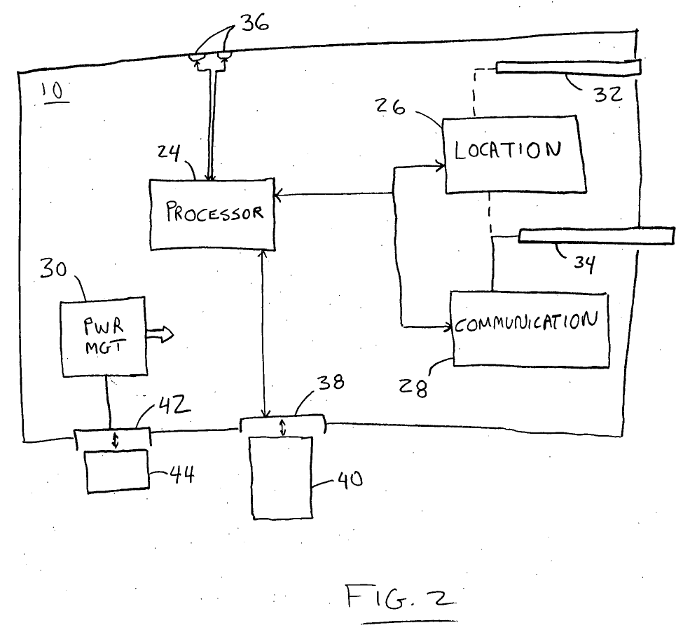

Details of modular tracking device 10 are shown in FIG. 2. A processor 24 provides overall control and coordination of the various electronic components and functions. The components include location and communication modules 26 and 28, and power management circuit 30. Location module 26 can be for instance a global positioning system (GPS) operating with its own antenna 32, or, optionally, with a shared antenna 34. Location module 26 conducts communication with earth-orbiting satellites 14 (FIG. 1) to determine the location of tracking device 10 in three-dimensional space (latitude, longitude, altitude) at a selected instant in time. The location information is conveyed to processor 24 and/or directly to communication module 28 for transmission to the server 18 and/or computer 20 as described above.

Location determination by location module 26 may be prompted by processor 24 at prescribed times, or it may be self-initiated by the location module, for example when a good communication link to satellite system 14 is detected. Prompting by processor 24 can take place in accordance with a prescribed regime that may be based on several factors, including for instance regularly-scheduled time intervals (every hour or daily, for example). Prompting may alternatively or additionally be event-driven, effected in response to user queries, to exceeding predetermined distances from known waypoints, or to deviating from an expected travel route, for instance. In the interest of conservation of power, communications can be reduced to the minimum amount required to maintain reasonable confidence of the whereabouts of the object.

Communication module 28 is configured to conduct communication to and from modular tracking device 10, using antenna 34, which may be shared with location module 26. Information transmitted from the tracking device 10 includes operational information that may include both location information and status information as mentioned above. Location information to be transmitted from the tracking device 10 may be provided to communication module 28 directly from location module 26, or by way of processor 24. The communication module 28 operates in accordance with any of a multitude of known protocols consistent with existing mobile communication infrastructure, and is equipped accordingly. Details of such provisions are omitted in the interest of clarity. Communication module 28, as well as location module 26, may be configured to observe communication silence, based on factors such as altitude (as determined by the location module 26), in order to avoid interference with avionics of an aircraft in which the tracking device may be borne during transport. During communication silence neither reception of signals by the communication module 28 and location module 26, nor transmission of signals by the communication module, is permitted.

Processor 24 is programmable such that various tracking device operational parameters can be provided thereto. Connection ports 36 are provided in modular tracking device 10 in order to effect such programming, and to obtain information about the tracking device, such as its ID. The connection ports 36 permit connection to an external device such as a personal computer (not shown), PDA or the like through which an operator can program the processor 24. Programming can entail for instance establishing the prescribed regime according to which the processor 24 will prompt the location module to make location determinations. The nature of events that underlie the event-driven prompting can thus be programmed into the processor 24, and a travel route and/or waypoints can be entered. In some embodiments, such information exchange and programming can be conducted wirelessly, dispensing with connection ports 36.

Also shown in FIG. 2 is a socket 38 for receiving an interchangeable integrated circuit card (ICC) 40, such as a SIM (subscriber identity module) type smart card or the like. The term socket as used herein is intended to encompass any receptacle, connector or other expedient configured to establish electrical communication between ICC 40 and one or more components of tracking device 10, which in this non-limiting example is processor 24. ICC 40 is configured to have some information storage capability, but it does not necessarily contain a processor. Thus it may be a memory card, which does not contain a processor, or it may be a microprocessor card, which contains both memory and processor. ICC 40 contains a unique card identifier, and an indication of a negotiated amount of access to existing mobile communication infrastructure 16 (FIG. 1). In this manner, ICC 40 enables modular tracking device 10 to use communication module 28 to communicate bidirectionally with server 18 and/or computer 20 by way of existing mobile communication infrastructure 16. The amount of communication access that ICC 40 enables is programmed into the ICC. Programming is typically performed in advance, and commercially, ICCs are sold with pre-programmed amounts which can be purchased in accordance with anticipated need. In the case of the shipped package example described herein, the amount of access required and thus purchased is based on the length of the shipping route, mode of travel (whether by air, land or sea) and the communication schedule (daily, hourly, event-driven, and so forth) desired.

FIG. 2 also shows a socket 42 for receiving an interchangeable power source, such as a NiCd, lithium, or other type of battery 44, which is either rechargeable or not. The term socket as used herein is intended to encompass any receptacle, connector or other expedient configured to establish electrical communication between ICC 40 and one or more components of tracking device 10, in this non-limiting example power management circuit 30, and/or a power delivery bus or similar conduit (not shown). Power from battery 44 is provided to power management module 30 for distribution to the other components of tracking device 10 as needed. Similar to ICC 40, the battery 44 is selected based on requirements, with its capacity being determined by the length of the shipping route, mode of travel (whether by air, land or sea) and the communication schedule (daily, hourly, event-driven, and so forth). Proper selection of the amount of communication access enabled by ICC 40, and of battery capacity provided by battery 44, provide cost savings advantages, particularly in volume shipping operations. Thus in the case of a shipping company that ships large numbers of packages daily, each tracking device 10 used with a package can be easily customized based on the character of the transit intended for the package. This is particularly relevant for tracking devices 10 that are intended to be for one-time use and disposable, as is contemplated for some applications. In that case, the tracking device 10 is customized with just enough power and communication access for a single trip. Such a one-time use disposable tracking device 10 can in effect be viewed as part of the shipping “package,” in that once the recipient receives the package, the container of the package, along with the tracking device which may be affixed thereto, are simply discarded. Since the tracking device 10 was customized for that particular shipment, it need not wastefully contain excess communication access enabled by ICC 40 or battery capacity provided by battery 44, as would be the case for a “one-size-fits-all” type tracking device which would have to be able to handle the longest and most power-intensive shipping tracking regime possible, regardless of the actual communication access and power capacity requirements. To further advance the interest of disposability, tracking device 10 can be made of low cost and off-the-shelf material and components.

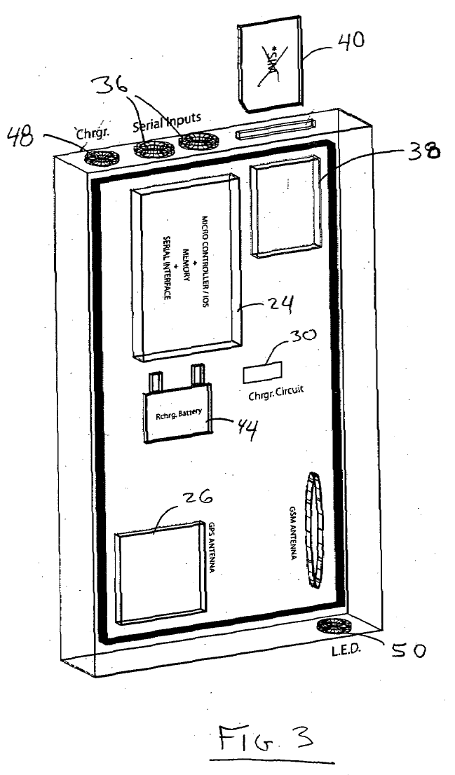

Tracking device 10 may have a conventional housing in which the various modules and components are disposed, as shown by way of example in FIG. 3, wherein only some of these components are shown for clarity. Such a housing 46 can also include a charger port 48 for charging battery 44, and a LED 50 or similar indicator (which may be audio) to provide various status and other indications.

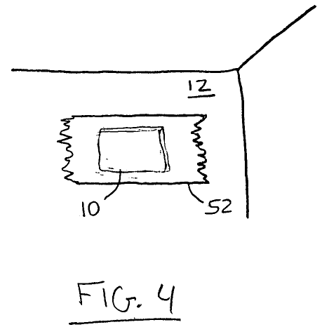

Tracking device 10 may have a reduced form factor, assuming the shape of an adhesive strip (tape) 52 that is affixed to the package 12 being shipped, as seen schematically in FIG. 4. With today's increased emphasis on miniaturization of electronic components, tracking device 10 can be made small enough to be embedded in adhesive strip 52, which itself can part of a shipping label affixed to the package. In alternative embodiments (not shown), depending on the tracking environment, tracking device 10 can be part of a stiff, adhesive label for cartons, part of a strong plastic case that can be hung from a lanyard or keychain, a fabric case that can be stitched into clothing, or of a biocompatible material for implantation into the body of human or animal.

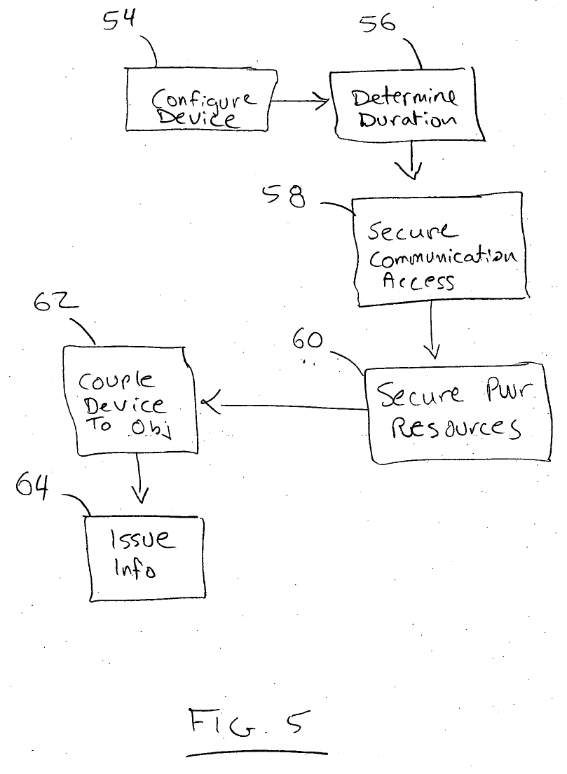

FIG. 5 illustrates a flow diagram of a tracking method, in which a tracking device 10 is configured at 54 to track the object. Configuring includes determining a tracking duration at 56, securing communication access for the tracking device for the tracking duration at 58, and securing power resources for the tracking device for the tracking duration at 60. Securing communication access can involve obtaining a suitable ICC 40 for coupling to the tracking device 10. Securing power resources can involve obtaining a suitable power supply 44 that will last for the duration. The tracking method also includes coupling the tracking device to the object at 62, for example by adhesion or similar means, and issuing information relating to the location of the object, by for example transmission by way of communication module 28, at 64.

The above are exemplary modes of carrying out the invention and are not intended to be limiting. It will be apparent to those of ordinary skill in the art that modifications thereto can be made without departure from the spirit and scope of the invention as set forth in the following claims.

1. A tracking device comprising:
a location module configured to determine location information relating to the tracking device;
a communication module configured to transmit said location information;
a processor in electrical communication with the location module and the communication module;
an ICC (integrated circuit card) socket communicatively coupled to the processor, the socket configured to receive an interchangeable ICC such that the ICC, when received by the ICC socket, is in communication with the processor; and
a power socket configured to receive an interchangeable power source and to distribute power from the interchangeable power source, when in the power socket, to the tracking device.

2. The tracking device of claim 1, wherein the ICC module is a SIM (subscriber identity module) card containing an indication of an amount of access to a mobile communication infrastructure upon which the communication module transmits said location information.

3. The tracking device of claim 1, wherein the location module is GPS (global positioning system) based, and wherein the communication module transmits said location information upon a determination of a strong GPS signal.

4. The tracking device of claim 1, wherein the communication module transmits said location information based upon queries received from a remote user.

5. The tracking device of claim 1, wherein one or both the location module and communication module are configured to observe communication silence based on a prescribed location condition.

6. The tracking device of claim 5, wherein the prescribed location condition is a function of altitude.

7. The tracking device of claim 1, wherein the communication module is configured to transmit status information of the tracking module, said status information including remaining battery life.

8. The tracking device of claim 1, wherein transmission of information by the communication module is a function of a prescribed time schedule.

9. The tracking device of claim 1, wherein transmission of information by the communication module is a function of the location of the tracking device.

10. The tracking device of claim 1, further comprising an adhesive strip to which the tracking device is affixed.

11. A system for tracking objects comprising:
one or more tracking devices each associated with an object, the tracking devices each including:
a location module configured to determine location information relating to the tracking device;
a communication module configured to transmit said location information;
a processor in electrical communication with the location module and the communication module;
an ICC (integrated circuit card) socket communicatively coupled to the processor, the socket configured to receive an interchangeable ICC such that the ICC, when received by the ICC socket, is in communication with the processor; and
a power socket configured to receive an interchangeable power source and to distribute power from the interchangeable power source, when in the power socket, to the tracking device; and
a server in communication with at least one of the tracking devices, the server configured to store location information transmitted by the communication module.

12. The system of claim 11, wherein the server is configured to provide access to the stored location information by a remote user.

13. The system of claim 12, wherein user access is gained following authentication.

14. The system of claim 12, wherein transmission of location information is in response to a query from the remote user.

15. A method for tracking an object comprising:
configuring a tracking device to track the object, said configuring including:
determining a tracking duration;
securing communication access for the tracking device for said tracking duration; and
securing power resources for the tracking device for said tracking duration;
coupling the tracking device to the object; and
issuing information relating to the location of the object.

16. The method of claim 15, further comprising storing the issued information on a server.

17. The method of claim 16, further comprising granting access to the stored information to a remote user.

18. The method of claim 17, wherein granting is conditioned upon authentication of the user.
